(19) United States
(12) Patent Application Publication
(10) Pub. No.: US 2026/0309554 A1
(43) Pub. Date: Oct. 8, 2026

(54) TEMPERATURE SENSOR AND DEVICE INCLUDING TEMPERATURE SENSOR

(71) Applicant: SEMITEC Corporation, Tokyo (JP)

(72) Inventors: Takehiro BABA, Tokyo (JP); Toshiyuki NOJIRI, Tokyo (JP)

(21) Appl. No.: 19/485,013

(22) PCT Filed: May 19, 2023
(86) PCT No.: PCT/JP2023/018837

§ 371 Date: Nov. 17, 2025

(51) Int. Cl. G01K 7/22; G01K 1/08

(52) U.S. Cl. CPC G01K 7/22; G01K 1/08

(57) ABSTRACT

A temperature sensor comprises a sensor element including a pair of leads connected to a thermosensitive element, a protective case accommodating the sensor element, a filler filling an area between the protective case and the sensor element inside the protective case, an electric wire electrically connected to the pair of leads and extending out of the protective case, a sealing material composed of an electrical insulator and covering an area from the thermosensitive element to predetermined positions of the pair of leads, and a dip resin composed of an electrical insulator and covering an area from the sealing material to predetermined positions of the pair of leads and the electric wire. Linear expansion coefficients of the sealing material, the dip resin, the thermosensitive element, and the pair of leads are set so that at least an area between the dip resin and the pair of leads does not separate during a temperature cycle between liquid nitrogen and boiling water.

### FIELD OF THE INVENTION

The present invention relates to a temperature sensor having favorable durability and capable of being used in a temperature range from a cryogenic temperature region to a high-temperature region, and to a device including the temperature sensor.

### BACKGROUND ART

Thermistor temperature sensors using a thermosensitive sintered body as a thermosensitive element are used to detect temperatures in home appliances such as air conditioners, refrigerators, and water heaters, medical devices, and devices mounted in vehicles such as automobiles, for example. Such temperature sensors are constantly subjected to temperature changes in an operating environment and are used under severe temperature conditions, requiring durability that can withstand cryogenic temperatures and high temperatures.

Conventionally, therefore, temperature sensors that improve heat cycle resistance as well as water resistance and thermal responsiveness have been proposed. Specifically, the temperature sensors are configured by arranging, inside a protective case having a bottomed pipe shape, lead wires connected via electrodes disposed on a surface of a thermosensitive sintered body, and filling the protective case with a filler (filling resin) surrounding the thermosensitive sintered body. With this configuration, it is possible to prevent a defect in which the filling resin separates from the protective case due to heat cycles, causing the filling resin to come out of the protective case together with the thermosensitive sintered body. Further, these temperature sensors also have a problem in that moisture from factors such as condensation at low temperatures penetrates an area surrounding the thermosensitive sintered body, causing defects.

In recent years, air conditioning devices such as air conditioners have been required to have performance that facilitates use from a cryogenic temperature region of −80° C. to a high-temperature region of 150° C. Further, temperature sensors in cooking appliances are required to measure high temperatures of 200° C. or higher. Furthermore, in the medical field, management in a cryogenic temperature region using liquid nitrogen and the like is required for gene preservation.

### PRIOR ART DOCUMENTS

### Patent Documents

Patent Document 1: Japanese Patent No. 6360273
Patent Document 2: Japanese Patent No. 6405074
Patent Document 3: Japanese Patent No. 6987305

### SUMMARY OF THE INVENTION

### Problems to be Solved by the Invention

However, in the above-described conventional temperature sensors, attention has been given to preventing the defect in which the thermosensitive sintered body comes out of the protective case together with the filling resin, but has not been paid to a change in characteristics, that is, resistance value, of the thermosensitive sintered body with respect to heat cycles over a wide temperature range from a cryogenic temperature region to a high-temperature region.

In particular, air conditioning devices and freezers have a wide temperature range from a temperature region of a cryogenic temperature of −80° C. or lower to a high-temperature region during abnormal periods in which a discharge pipe temperature of an outdoor unit reaches a high temperature of 150° C. However, a wide-range temperature sensor that can cover these temperature regions in a single temperature sensor does not exist.

Further, in temperature sensors used in extremely humid atmospheres with high moisture content, moisture penetrates internally even through minute gaps. When this moisture reaches an area between a pair of conductors (leads) connected to the thermosensitive element, the moisture causes an electrical short circuit. Temperature sensors repeatedly undergo temperature rises and falls and thus, when the conductors and members surrounding the conductors repeatedly expand and contract, gaps are likely to form around the conductors. Consequently, in humid atmospheres, there is an increased risk of moisture penetrating the conductors.

An object of an embodiment of the present invention is to provide a temperature sensor that can not only prevent a defect in which a thermosensitive element comes out of a protective case together with a filling resin, but also suppress a change in characteristics of the thermosensitive element and ensure reliability, and a device including this temperature sensor.

Further, an object of an embodiment of the present invention is to provide a temperature sensor capable of preventing formation of a gap around a conductor (lead) or, if the gap is formed, suppressing the formation to a minimum, thereby suppressing a short circuit even when the temperature sensor is used in a humid atmosphere.

### Means for Solving the Problems

A temperature sensor according to an embodiment of the present invention comprises a sensor element including a thermosensitive element and a pair of leads electrically connected to the thermosensitive element, a protective case accommodating the sensor element, a filler filling an area between the protective case and the sensor element inside the protective case, an electric wire electrically connected to the pair of leads and extending out of the protective case, a sealing material composed of an electrical insulator and covering an area from the thermosensitive element to predetermined positions of the pair of leads, and a dip resin composed of an electrical insulator and covering an area from the sealing material to predetermined positions of the pair of leads and the electric wire. Linear expansion coefficients of the sealing material, the dip resin, the thermosensitive element, and the pair of leads are set so that at least an area between the dip resin and the pair of leads does not separate during a temperature cycle between liquid nitrogen and boiling water.

Further, a device provided with a temperature sensor according to an embodiment of the present invention is a device comprising the temperature sensor of the embodiment of the present invention.

Devices provided with a temperature sensor include various devices provided with a temperature sensor for various temperature detection, such as thermistors using a thermosensitive body as a thermosensitive element to detect temperatures in home appliances such as air conditioners, refrigerators, and water heaters, medical devices, and devices mounted in vehicles such as automobiles. The devices to which the temperature sensor is applied are not particularly limited.

### Effect of the Invention

According to an embodiment of the present invention, it is possible to provide a temperature sensor capable of preventing a defect in which a thermosensitive element comes out of a protective case together with a filling resin, and preventing moisture penetration even under harsh environments in a cryogenic temperature region or a high-temperature region, suppressing a change in characteristics of the thermosensitive element, and ensuring reliability, and a device including this temperature sensor.

Further, it is possible to provide a temperature sensor that can be used in a wide temperature range from cryogenic temperature to high-temperature regions and has favorable durability and a wide scope of applications, and a device including the temperature sensor.

### BRIEF DESCRIPTION OF THE DRAWINGS

FIG. 1 is a sectional plan view illustrating a temperature sensor according to an embodiment of the present invention.

FIG. 2 is a sectional front view illustrating the same temperature sensor.

FIG. 3 is a table showing linear expansion coefficients of each member of the same temperature sensor.

FIG. 4 is a sectional front view illustrating the temperature sensor according to another embodiment of the present invention.

FIG. 5 is a sectional plan view similarly illustrating the temperature sensor according to another embodiment of the present invention.

FIG. 6 is a sectional front view illustrating a temperature sensor of a comparative example.

FIG. 7 is a table showing comparative evaluation results obtained by implementing a temperature cycle of 20,000 cycles, with one cycle set as one minute in water at 5° C. to one minute in water at 85° C. as test conditions.

FIG. 8 is a table showing comparative evaluation results obtained by implementing a temperature cycle of 10 cycles, with one cycle set as one minute in liquid nitrogen at −196° C. to one minute in silicon oil at 206° C. as test conditions.

FIG. 9 is a table showing comparative evaluation results obtained by implementing a temperature cycle of 20 cycles, with one cycle set as one minute in liquid nitrogen at −196° C. to one minute in boiling water at 100° C. as test conditions.

FIG. 10 is a table showing comparative evaluation results obtained by implementing a temperature cycle of 10,000 cycles, with one cycle set as 10 minutes in silicon oil at −30° C. to 10 minutes in silicon oil at 150° C. as test conditions.

FIG. 11 is a table showing comparative evaluation results obtained by conducting, with a boiling electrification test as a test condition, an evaluation after the elapse of 1,340 hours in boiling water at 100° C.

### EMBODIMENTS OF THE INVENTION

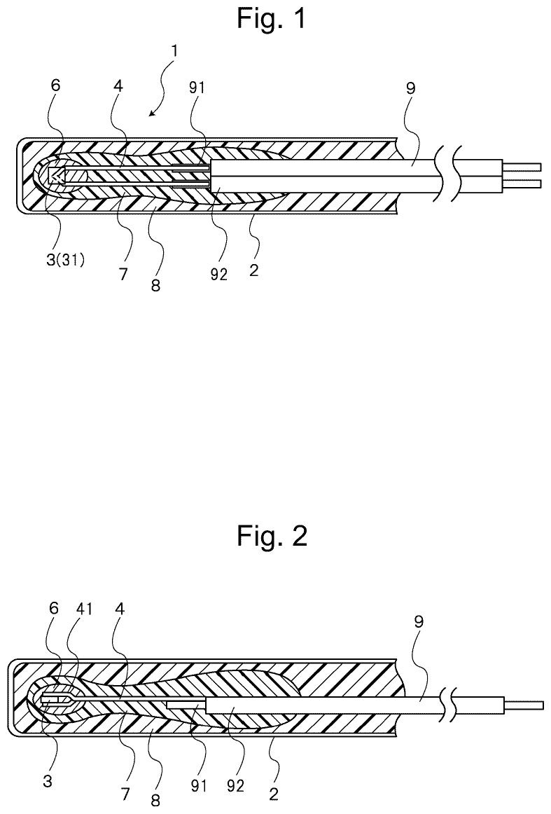

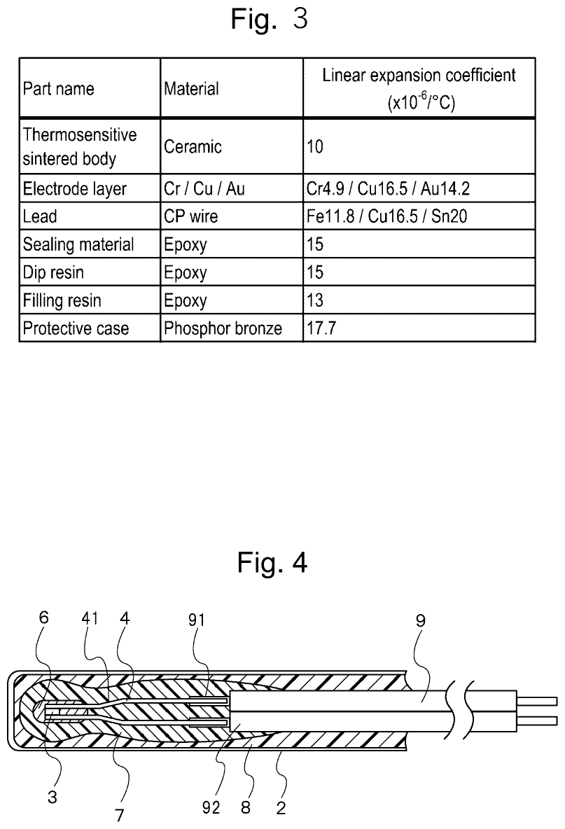

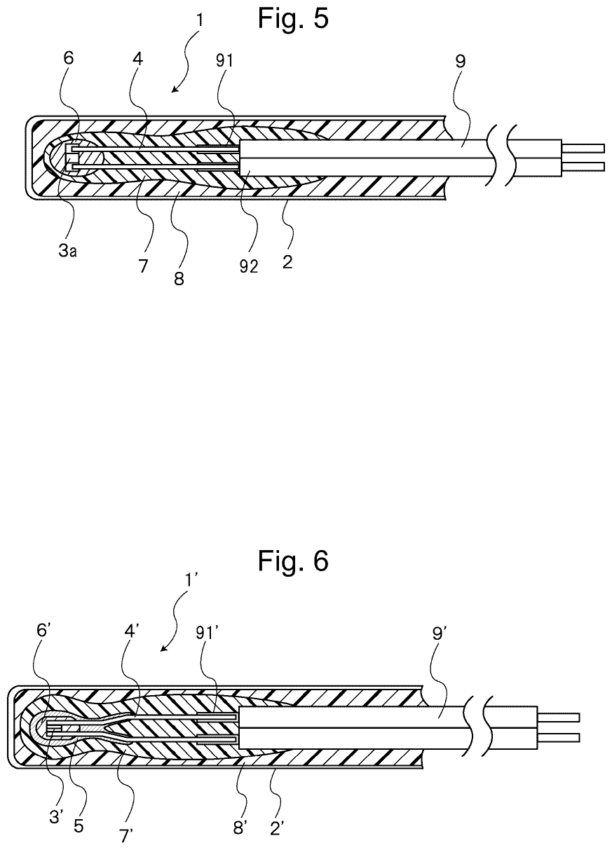

Hereinafter, a temperature sensor according to an embodiment of the present invention will be described with reference to FIG. 1 to FIG. 5. FIG. 1 and FIG. 2 are sectional plan and front views illustrating the temperature sensor, FIG. 3 is a table showing linear expansion coefficients of each member, and FIG. 4 and FIG. 5 are sectional front and plan views illustrating the temperature sensor according to another embodiment of the present invention. It should be noted that, in the drawings, the same or corresponding portions are denoted by the same reference signs, and duplicate descriptions are omitted. Further, for explanatory purposes, the scale of each member is changed as appropriate so that each member can be recognized.

As illustrated in FIG. 1 and FIG. 2, a temperature sensor 1 is a thermosensitive resistor having thermosensitive capabilities, and includes a protective case 2, a thermosensitive body 3 of a thermosensitive element, leads 4, a sealing material 6, a dip resin 7, a filling resin 8 that is a filler, and an electric wire 9.

The thermosensitive body 3 is preferably a thermosensitive sintered body, but is not limited to a thermosensitive sintered body, may be constituted by a platinum resistor, a thin-film thermistor, or a thermocouple, and is not particularly limited to any specific type. In the case of a platinum resistor or a thin-film thermistor formed on an insulating substrate, use of an ultrathin glass substrate as the substrate makes it possible to significantly increase a thermal time constant thereof.

The sensor element is constituted by the thermosensitive body 3 of the thermosensitive element and the leads 4. The leads 4 are connected to the thermosensitive body 3, and this connection is sealed by the sealing material 6. The leads 4 are electrically connected to each core wire 91 of the electric wire 9. Furthermore, the thermosensitive body 3 is disposed inside the protective case 2, insulated by the dip resin 7, and configured so that a surrounding area thereof is filled with the filling resin 8.

The protective case 2 is formed of a resin or metal material, has a bottomed pipe shape open on one end side, and is formed in a cylindrical shape or a square-cylindrical shape. Generally, a cylindrical shape having an outer diameter of 6 to 8 mm and a length dimension of 20 to 30 mm is selected.

In a case in which the material of the protective case 2 is resin, preferably a high heat-resistant resin such as polyphenylene sulfide (PPS), liquid crystal polymer, polyamide-imide (PAI), or polyetherimide (PEI) is used. This makes it possible to ensure a heat resistance of 200° C.. Further, in a case in which the material of the protective case 2 is metal, copper (Cu), iron (Fe), chromium (Cr), nickel (Ni), aluminum (Al), zinc (Zn), titanium (Ti), or an alloy containing at least one thereof can be used.

Further, in a case in which the material of the protective case 2 is resin, desirably plating of a metal such as described above, that is, copper (Cu), iron (Fe), chromium (Cr), nickel (Ni), aluminum (Al), zinc (Zn), titanium (Ti), or an alloy containing at least one thereof, is applied to the protective case 2 of this resin.

Furthermore, the metal plating is applied to the protective case 2 of resin, making it possible to improve a water resistance and an oil resistance of the temperature sensor 1.

In a case of being a thermosensitive sintered body, the thermosensitive body 3 is a thermistor, formed in a substantially rectangular parallelepiped shape, and constituted by a thermistor material of an oxide containing, as a main component, a composite metal oxide composed of two or more elements selected from transition metal elements such as manganese (Mn), nickel (Ni), cobalt (Co), iron (Fe), yttrium (Y), chromium (Cr), copper (Cu), and zinc (Zn) and having a crystalline structure. Further, subcomponents may be contained for improving characteristics and the like. Compositions and contents of the main components and the subcomponents can be determined, as appropriate, in accordance with desired characteristics.

Further, the thermosensitive body 3 may be composed of a silicon (Si)-based ceramic such as silicon carbide (SiC) or silicon nitride (Si₃N₄). Furthermore, the shape of the thermistor is not limited to a substantially rectangular parallelepiped shape, and a disc shape, a polygonal shape, or the like can be selected, as appropriate.

Accordingly, the thermosensitive body 3 can be formed of a compound semiconductor of metal oxide or metal nitride. It should be noted that, to allow use in a wide temperature range, the thermosensitive body 3 may have a low B-constant characteristic. Further, an electrode layer 31 is formed on a surface of the thermosensitive body 3.

The leads 4 are a pair and are conductors of lead wires having conductivity, are electrically connected, by welding, soldering, or the like, to the electrode layer 31 of gold (Au), chromium (Cr), copper (Cu), platinum (Pt), or the like formed on the surface of the thermosensitive body 3, and are drawn out through the opening on the one end side of the protective case 2. These leads 4 are electrically connected to the core wires 91 of the electric wire 9 by soldering or the like, and insulated by an insulation coating 92. It should be noted that the electrode layer 31 and the like constituting the sensor element do not contain silver (Ag). This is to avoid migration.

As a material of the leads 4, Dumet wire or a copper-clad steel (CP) wire is preferably used. The material of the leads 4 is copper (Cu), iron (Fe), chromium (Cr), nickel (Ni), aluminum (Al), zinc (Zn), titanium (Ti), tin (Sn), or an alloy containing at least one thereof, and copper-plated wire, copper-tin-plated wire, copper-clad wire, or the like with these used as a core material.

As a form of the leads 4, any type, such as a single wire or a square wire, can be applied. A length dimension of the leads 4 is typically 5 to 15 mm. The length dimension is selected in consideration of a size of the protective case 2. It should be noted that the pair of leads 4 are formed with bent portions 41 on tip end sides thereof to ensure alignment parallel to a pitch of the core wires 91 of the electric wire 9. Specifically, an interval of 1 mm or greater is maintained. Further, connection portions that are tip end portions of the leads 4 and connect to the electrode layer 31, are disposed in an oblique direction and connected to the surface of the thermosensitive body 3.

Furthermore, a cross-sectional area of the leads 4 is 0.097 mm 2 or less. The cross-sectional area of the leads 4 is considered to be closely related to a resistance value change of the thermosensitive body 3. There is a tendency in which an increase in the cross-sectional area of the leads 4 results in an increase in the resistance value change.

Accordingly, it has been found that, if the cross-sectional area of the leads 4 is small and 0.097 mm 2 or less, the resistance value change can be suppressed to a minimum. This is presumably due to the fact that, when the leads 4 are thick and have a large cross-sectional area, a force applied to the thermosensitive body 3 increases. In addition, the leads 4 are thin and have a small cross-sectional area, decreasing heat dissipation from the leads 4 and making accurate temperature detection possible. It should be noted that, in a case in which a plurality of the leads 4 are used, the cross-sectional area of the leads 4 can be understood as a total cross-sectional area of the plurality of leads.

The sealing material 6 covers and protects the thermosensitive body 3, and an insulating resin having a high heat-resistant temperature, such as an epoxy resin, is used. This makes it possible to effectively protect the thermosensitive body 3 and the like, even in a case of use under a high-temperature environment. Further, the sealing material 6 may be an acid anhydride-based epoxy resin containing a filler.

The dip resin 7 is provided surrounding the thermosensitive body 3, obtaining a structure that ensures insulation, including an area between the leads 4 and each core wire 91 of the electric wire 9 electrically connected to the leads 4. This dip resin 7 is provided by dipping the thermosensitive body 3, to which the leads 4 are connected, into an insulating resin.

Here, a detailed explanation will be given focusing on a linear expansion coefficient of the dip resin 7. This is a method for achieving a linear expansion coefficient of 20×10⁻⁶/° C. or less for the dip resin 7.

In a case in which the filling resin 8 is an epoxy resin, this epoxy resin having a linear expansion coefficient of 20×10⁻⁶/° C. or less can be relatively easily obtained. In the case of the filling resin 8, unlike the dip resin 7, thixotropic properties are not required, making it possible to relatively easily realize a linear expansion coefficient of 20×10⁻⁶/° C. or less by adding a filler in an appropriate amount to a main agent.

It is known as a common technique that an epoxy resin is typically used by blending two liquids of a main agent and a curing agent. In the case of the dip resin 7, thixotropic properties, which are properties that prevent a dipped resin from dripping, are required. At this point, for the dip resin 7 requiring thixotropic properties, no epoxy resin having a linear expansion coefficient of 20×10⁻⁶/° C. or less has been found.

The inventors, by using a special blending method, achieved a dip epoxy resin that is a dip resin requiring thixotropic properties and has a linear expansion coefficient of 20×10⁻⁶/° C. or less. Specifically, the dip epoxy resin is realized by adding, to an epoxy resin not having thixotropic properties and obtained by blending the two liquids of a main agent and a curing agent, at least one or more resin compositions so as to be imparted with thixotropic properties.

In a case in which such a special blending method is not used, it is difficult to obtain a dip epoxy resin imparted with thixotropic properties and having a linear expansion coefficient of 20×10⁻⁶/° C. or less.

It should be noted that, for the dip resin 7, an acid anhydride-based epoxy resin containing a filler can be used. In the case of such a dip resin 7, it is possible to obtain a dip epoxy resin having thixotropic properties and a linear expansion coefficient of 20×10⁻⁶/° C. or less. With use of a dip epoxy resin containing a filler, an effect of improving a thermal conductivity of the dip epoxy resin and increasing the thermal time constant is achieved. While the conventional configuration has a thermal time constant of 10 seconds, the dip epoxy resin containing a filler having favorable thermal conduction properties has a thermal time constant of five seconds. The dip resin 7 containing a filler has a thermal conductivity of 0.6 W/m·K or greater.

Further, conventional epoxy resins having flexibility have a problem in that uncured resins cause elution of epoxy components due to moisture such as humidity. However, the dip epoxy resin of this embodiment does not have flexibility, and thus the problem of epoxy component elution does not occur.

The filling resin 8 that is a filler fills an area surrounding the thermosensitive body 3 inside the protective case 2. Specifically, the filling resin 8 is an acid anhydride-based epoxy resin, and fills the surrounding area, including the sealing material 5 covering the thermosensitive body 3 and the connection portion sides of the leads 4 connecting to the thermosensitive body 3.

It should be noted that the filling resin 8 may contain a filler composed of ceramic, metal, carbon, or the like having favorable thermal conduction properties.

For the temperature sensor 1 such as described above, FIG. 3 shows the linear expansion coefficients of each member. The linear expansion coefficients are adjusted and set to 20×10⁻⁶/° C. or less, similar to the dip resin 7 mentioned above. The thermosensitive body 3, which is the thermosensitive element, the leads 4, the sealing material 6, the dip resin 7, and the protective case 2 are preferably set to linear expansion coefficients of 7.5 to 19.5×10⁻⁶/° C., and specifically adjusted and set to 20×10⁻⁶/° C. or less.

FIG. 4 illustrates the temperature sensor according to another embodiment of the present invention. FIG. 4 illustrates a sectional front view, and the temperature sensor 1 of this embodiment has basically the same configuration as the configuration of the embodiment mentioned above. The sealing material 6 that covers and protects the thermosensitive body 3, which is the thermosensitive element, is glass, and crystallized glass or the like is used. This makes it possible to effectively protect the thermosensitive body 3 and the like even in a case in which the temperature sensor 1 is used under a high-temperature environment. Further, the pair of leads 4 are formed so as to include the bent portions 41 that have narrow widths on the tip end sides so as to match the pitch of the core wire 91 of the electric wires 9, and thus maintain an interval of 1 mm or greater.

FIG. 5 is a sectional plan view of the temperature sensor, illustrating a case in which the thermosensitive body of the thermosensitive element is a thin-film thermistor 3a. The thin-film thermistor 3a is formed by depositing a thin film of a thermistor composed of an oxide semiconductor having a negative temperature coefficient on an insulating substrate of inorganic material by a sputtering method. It should be noted that the thermosensitive body of the thermosensitive element may be a platinum resistor and, in this case as well, a thin film is deposited and formed on an insulating substrate of inorganic material. Further, the insulating substrate of inorganic material is desirably an ultrathin glass substrate having a thickness dimension of 100 μm or less, for example.

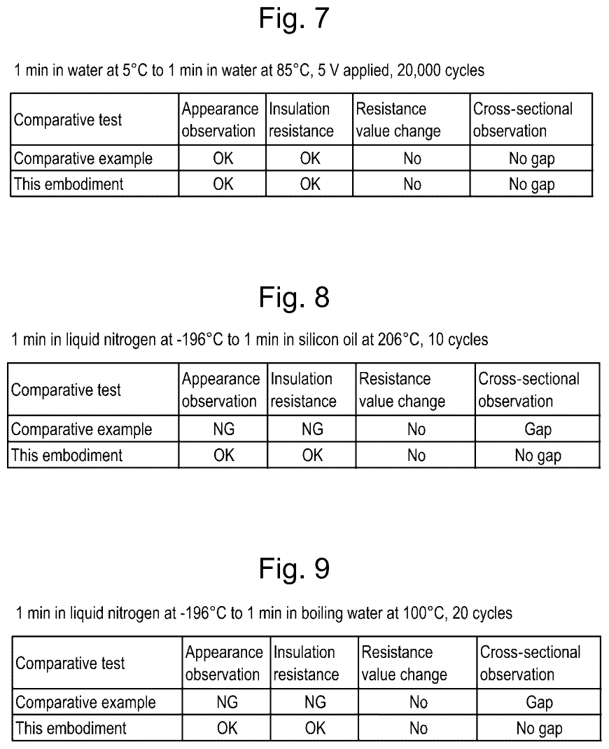

Next, results obtained by implementing comparative evaluation tests between the temperature sensor 1 configured as described above and a temperature sensor of a comparative example will be described with reference to FIG. 7 to FIG. 11.

First, FIG. 6 illustrates a structure of the comparative example. A temperature sensor 1′ includes a protective case 2′, a thermosensitive body 3′, leads 4′, an undercoat material 5, a sealing material 6′, a dip resin 7′, a filling resin 8′, and an electric wire 9′. Incidentally, the protective case 2′ is made of metal, the undercoat material 5 is silicone rubber, the sealing material 6′ is made of glass, and the dip resin 7′ and the filling resin 8′ are epoxy resin.

FIG. 7 is a table showing comparative evaluation results. Test conditions include immersing the temperature sensor in water and implementing a temperature cycle of 20,000 cycles with 5 V applied and one cycle set as one minute in water at 5° C. to one minute in water at 85° C.. Comparative test items include appearance observation of observing deformation, damage, and the like of the protective case, ensured state of insulation resistance, and cross-sectional observation of observing resistance change in the thermosensitive element, occurrence of a gap around the leads, and the like.

These test conditions include a general waterproof test, and differences between this embodiment and the comparative example did not occur in this evaluation.

FIG. 8 is a table similarly showing comparative evaluation results. The test conditions include immersing the temperature sensor in liquid and implementing a temperature cycle of 10 cycles, with one cycle set as one minute in liquid nitrogen at −196° C. to one minute in silicon oil at 206° C.

In the temperature cycle test in liquid from the cryogenic temperature of −196° C. to 206° C., the comparative example showed deformation and damage of the protective case 2′, resulting in an unfavorable (not good: NG) appearance observation. Further, a gap occurred between the leads 4′ (including the undercoat material 5 of silicone rubber) and the dip resin 7′ and thus, in the underwater insulation test, water penetrated, causing failure to ensure insulation resistance and an NG result. In contrast, this embodiment was confirmed as having no abnormalities.

FIG. 9 is a table similarly showing comparative evaluation results. The test conditions include immersing the temperature sensor in liquid and implementing a temperature cycle of 20 cycles, with one cycle set as one minute in liquid nitrogen at −196° C. to one minute in water (boiling water) at 100° C.

As in FIG. 8, the comparative example showed deformation and damage of the protective case 2′, resulting in an NG appearance observation, a gap occurred between the leads 4′ (including the undercoat material 5 of silicone rubber) and the dip resin 7′, resulting in an NG cross-sectional observation and, in the underwater insulation test, water penetrated, causing failure to ensure insulation resistance and thus resulting in an NG insulation resistance. In contrast, this embodiment was confirmed as having no abnormalities.

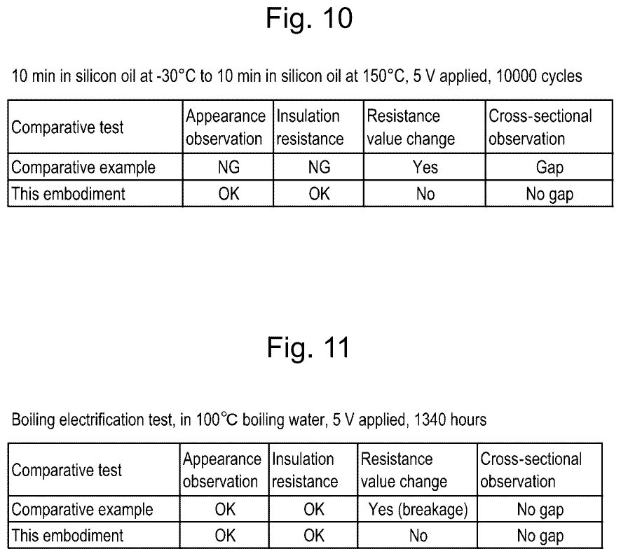

FIG. 10 is a table similarly showing comparative evaluation results. The test conditions include immersing the temperature sensor in liquid and implementing a temperature cycle of 10,000 cycles with 5 V applied and one cycle set as 10 minutes in silicon oil at −30° C. to 10 minutes in silicon oil at 150° C.

The comparative example showed deformation and damage of the protective case 2′, resulting in an NG appearance observation, a gap occurred between the leads 4′ (including the undercoat material 5 of silicone rubber) and the dip resin 7′, resulting in an NG cross-sectional observation and, in the underwater insulation test, water penetrated, causing failure to ensure insulation resistance and thus resulting in an NG insulation resistance. Further, a resistance change in the thermosensitive element occurred. In contrast, this embodiment was confirmed as having no abnormalities. Thus, there was no gap in the penetration path of the water, making it possible to achieve an effect of preventing the penetration of water.

FIG. 11 is a table similarly showing comparative evaluation results. The test conditions include a boiling electrification test, evaluation was performed after the elapse of 1,340 hours, with the temperature sensor immersed in boiling water at 100° C. and 5 V applied.

In the 100° C. boiling electrification test, it was confirmed that the leads 4′ broke at a portion where the undercoat material 5 of silicone rubber was present in the comparative example, whereas there were no abnormalities in this embodiment.

As described above, in the comparative example, to improve weather resistance in humid atmospheres, the thermosensitive body 3′ and the leads 4′ thereof are insulation-coated with the dip resin 7′ of silicone rubber, epoxy resin, or the like having elasticity, thereby attempting to prevent moisture penetration. However, in cryogenic temperature regions, the silicone rubber and the epoxy resin deteriorate in elastic performance, lose elasticity, and harden, resulting in a problem in that a gap is formed between the leads 4′ and separation occurs, failing to prevent moisture penetration. Furthermore, silicone rubber has a large linear expansion coefficient, and thus applies a load to the leads 4′, causing the risk of breakage.

According to this embodiment, it is possible to obtain the temperature sensor 1 capable of being used in a wide range from a cryogenic temperature of −196° C. to a high-temperature of 206° C., and provide the temperature sensor 1 capable of preventing an defect in which the thermosensitive body 3 comes out of the protective case 2 together with the filling resin 8, and preventing moisture penetration even under harsh environments in cryogenic temperature regions or high-temperature regions, suppressing a change in the characteristics of the thermosensitive body 3, and ensuring reliability.

Further, as shown in FIG. 9, this embodiment has a configuration in which the linear expansion coefficients of the sealing material 6, the dip resin 7, the thermosensitive element, and the leads 4 are set so that at least the area between the dip resin 7 and the leads 4 does not separate during temperature cycles between liquid nitrogen and boiling water. Specifically, in the thermosensitive body 3, which is the thermosensitive element, the leads 4, the sealing material 6, the dip resin 7, and the protective case 2, the linear expansion coefficients are adjusted and set to 20×10⁻⁶/° C. or less.

Further, the above-described temperature sensor 1 can be applied to various temperature sensors such as a thermistor using a thermosensitive body as a thermosensitive element to detect temperatures in home appliances such as air conditioners, refrigerators, and water heaters, medical devices, and devices mounted in vehicles such as automobiles. The devices to which the temperature sensor 1 is applied are not particularly limited.

It should be noted that the present invention is not limited to the configurations of the above-described embodiments, and various modifications are possible without departing from the gist of the invention. Further, the above-described embodiments are presented as examples, and are not intended to limit the scope of the invention. These new embodiments can be implemented in various other forms, and various omissions, substitutions, and changes can be made. These embodiments and modifications thereof are included in the scope and gist of the invention, and in the scope of the invention and its equivalents described in the claims.

### DESCRIPTIONS OF REFERENCE NUMERALS

1 Temperature sensor
2 Protective case
3 Thermosensitive body (Thermosensitive sintered body)
3a Thermosensitive body (Thin-film thermistor)
31 Electrode layer
4 Lead
41 Bent portion
5 Undercoat material
6 Sealing material
7 Dip resin
8 Filling resin (Filler)
9 Electric wire
91 Core wire
92 Insulation coating

1-16. (canceled)

17. A temperature sensor comprising:
a sensor element including a thermosensitive element and a pair of leads electrically connected to the thermosensitive element;
a protective case accommodating the sensor element;
a filler filling an area between the protective case and the sensor element inside the protective case;
an electric wire electrically connected to the pair of leads and extending out of the protective case;
a sealing material composed of an electrical insulator and covering an area from the thermosensitive element to predetermined positions of the pair of leads; and
a dip resin composed of an electrical insulator and covering an area from the sealing material to predetermined positions of the pair of leads and the electric wire,
linear expansion coefficients of the protective case, the sealing material, the dip resin, the thermosensitive element, and the pair of leads being 20×10⁻⁶/° C. or less.

18. The temperature sensor according to claim 17, wherein
the dip resin is composed of a resin having thixotropic properties and does not have flexibility.

19. The temperature sensor according to claim 18, wherein
the dip resin is configured by adding, to an epoxy resin not having thixotropic properties and obtained by blending two liquids of a main agent and a curing agent, at least one or more resin compositions so as to be imparted with thixotropic properties.

20. The temperature sensor according to claim 18, wherein
the dip resin is composed of an acid anhydride-based epoxy resin containing a filler and has a thermal conductivity of 0.6 W/m·K or greater.

21. The temperature sensor according to claim 17, wherein a cross-sectional area of the pair of leads is 0.097 mm² or less.

22. The temperature sensor according to claim 17, wherein
the thermosensitive element is a thermosensitive sintered body and is a compound semiconductor of metal oxide or metal nitride.

23. The temperature sensor according to claim 17, wherein
the thermosensitive element is a platinum resistor or a thin-film thermistor formed on an insulating substrate of inorganic material.

24. The temperature sensor according to claim 17, wherein
the thermosensitive element is a platinum resistor or a thin-film thermistor formed on an ultrathin glass substrate.

25. The temperature sensor according to claim 17, wherein
the pair of leads are formed so as to match a pitch of core wires of the electric wire.

26. The temperature sensor according to claim 17, wherein
the sealing material is glass or resin.

27. The temperature sensor according to claim 17, wherein
the filler and the sealing material are acid anhydride-based epoxy resins containing a filler.

28. The temperature sensor according to claim 17, wherein
a material of the protective case is resin and is polyphenylene sulfide (PPS), liquid crystal polymer, polyamide-imide (PAI), or polyetherimide (PEI).

29. The temperature sensor according to claim 17, wherein
a material of the protective case is copper (Cu), iron (Fe), chromium (Cr), nickel (Ni), aluminum (Al), zinc (Zn), titanium (Ti), or an alloy containing at least one thereof.

30. The temperature sensor according to claim 17, wherein
a material of the pair of leads is copper (Cu), iron (Fe), chromium (Cr), nickel (Ni), aluminum (Al), zinc (Zn), titanium (Ti), or an alloy containing at least one thereof.

31. The temperature sensor according to claim 17, wherein
a material of the pair of leads is copper (Cu), iron (Fe), chromium (Cr), nickel (Ni), aluminum (Al), zinc (Zn), titanium (Ti), tin (Sn), or an alloy containing at least one thereof, and a copper-plated wire, a copper-tin-plated wire, or a copper-clad wire with these used as a core material.

32. A device provided with a temperature sensor, the device comprising:
the temperature sensor described in claim 17.
